(19) United States
(12) Patent Application Publication
(10) Pub. No.: US 2025/0110454 A1
(43) Pub. Date: Apr. 3, 2025

(54) DIGITAL TWIN SYSTEMS MANAGEMENT

(71) Applicant: CBRE, INC., DALLAS, TX (US)

(72) Inventors: Anno J. SCHOLTEN, Grapevine, TX (US); Damian Patrick HICKEY, London (UA); Yash TULI, London (UA); Travis Jeremy CRINER, Hurricane, WV (US)

(73) Assignee: CBRE, INC., DALLAS, TX (US)

(21) Appl. No.: 18/899,676

(22) Filed: Sep. 27, 2024

Related U.S. Application Data
(60) Provisional application No. 63/541,155, filed on Sep. 28, 2023.

(51) Int. Cl. G05B 13/04; G05B 13/02

(52) U.S. Cl. CPC G05B 13/041; G05B 13/0265

(57) ABSTRACT

At least one processor may receive data descriptive of operation of equipment and store the data in a data store. the at least one processor may build a digital twin of the equipment using the data by training at least one machine learning model on at least a portion of the data in the data store and building a model accessible by a user interface and comprising at least one parameter determined by the trained machine learning model. The at least one processor may simulate operation of the equipment using the digital twin in response to receiving an entry in at least one user-variable input included in the model.

### CROSS-REFERENCE TO RELATED APPLICATION

This application claims priority from U.S. Provisional Application No. 63/541,155, entitled “Digital Twin Systems Management” and filed on Sep. 28, 2023, the entirety of which is incorporated herein by reference.

### BACKGROUND

For many devices, operators employ control techniques intended to balance operational efficiency with performance. For example, in the field of heating, ventilation, and air conditioning (HVAC), operators may try to reduce energy consumption and maintenance costs of equipment such as chiller units of buildings, while still providing a comfortable environment for building occupants. Continuing the chiller unit example, in many cases, chiller units can be responsible for 30-50% of a building's energy consumption and up to 40% of a building's demand energy charge. At the same time, chiller units can generate high maintenance costs due to improper operations such as heavy cycling. These issues can be generalized to a variety of systems in the HVAC realm and beyond.

### BRIEF DESCRIPTIONS OF THE DRAWINGS

FIG. 1 shows an example equipment management system according to some embodiments of the disclosure.

FIG. 2 shows an example digital twin development and implementation process according to some embodiments of the disclosure.

FIG. 3 shows an example data collection process according to some embodiments of the disclosure.

FIG. 4 shows an example digital twin building process according to some embodiments of the disclosure.

FIG. 5A shows an example simulation process according to some embodiments of the disclosure.

FIG. 5B shows an example simulation user interface according to some embodiments of the disclosure.

FIG. 6 shows a computing device according to some embodiments of the disclosure.

### DETAILED DESCRIPTION OF SEVERAL EMBODIMENTS

Systems and methods described herein address the problems discussed above through improved techniques for energy consumption and operational modeling, analysis, optimization, and control. For example, systems and methods described herein can use one or more machine learning (ML) techniques to automatically build a digital twin of a piece of real equipment using data gathered by observing the real equipment. The digital twin built as described herein is improved compared with other digital twin construction techniques because it is built automatically and represents an accurate model based on real data. Running tests including changing operating parameters of the digital twin, whether done automatically or by user experimentation, can therefore provide highly accurate understanding of how the real equipment will respond in similar scenarios and, therefore, enable better control of the equipment with higher efficiency, reliability, and efficacy.

For example, embodiments described herein may ingest data gathered by sensors configured to monitor a piece of equipment and/or conditions affected by its operation. Such embodiments can use automated processes such as ML algorithms to identify variables impacting energy consumption (and/or other factors of interest), model variables to control and predict energy consumption, and overlay the modeled data on a digital twin to simulate predicted energy consumption. As a result, the equipment can be controlled to realize significant energy savings with optimized functional operations. Moreover, preventative maintenance based on anticipated future problems identified through simulation can provide significant cost and downtime savings.

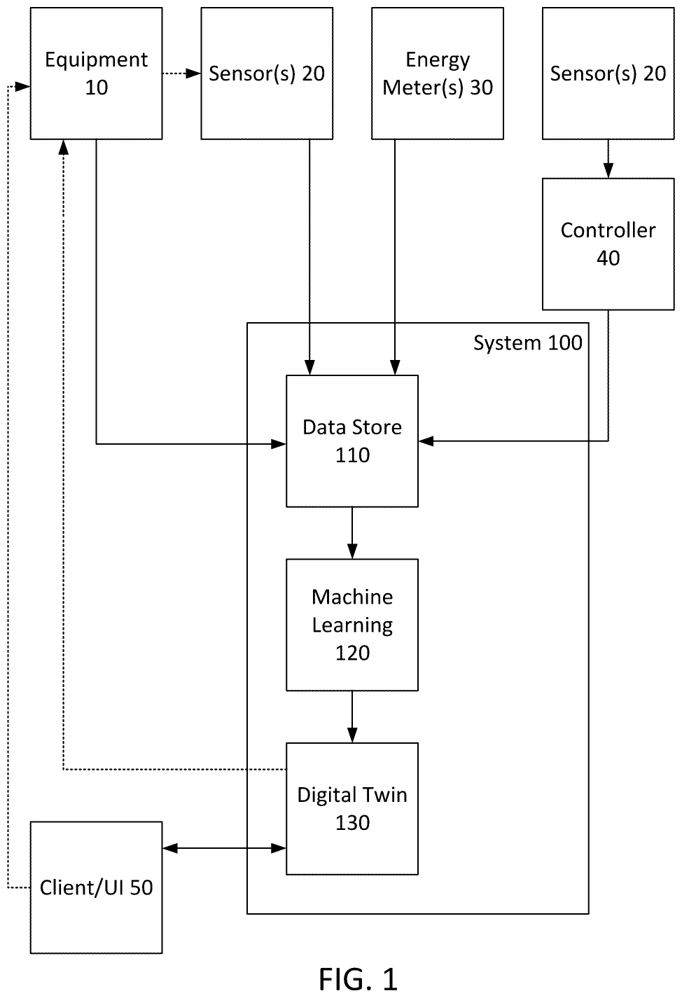

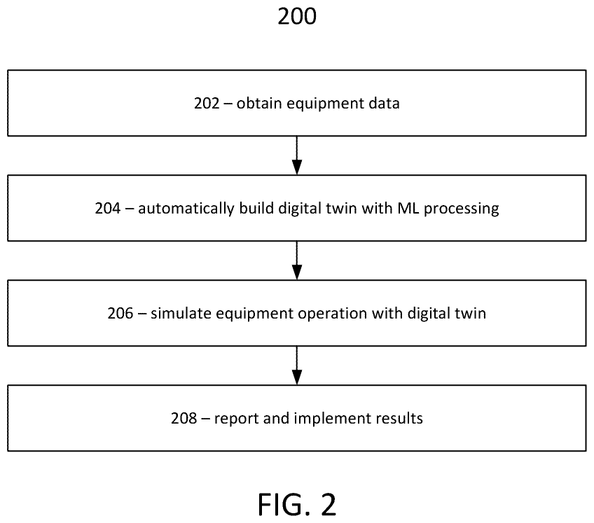

FIG. 1 shows an example equipment management system 100 according to some embodiments of the disclosure. System 100 may include a variety of hardware, firmware, and/or software components that interact with one another, such as data store 110, ML processing 120, and/or digital twin processing 130. The functions and operations of data store 110, ML processing 120, and digital twin processing 130 are described in greater detail below, but in general, one or more elements such as equipment 10 (e.g., a chiller or other device), sensor(s) 20 (which may be stand alone or may be coupled to or in communication with equipment 10), energy meter(s) 30, and/or controller 40 (which may receive data from sensor(s) 20) can send data to data store 110. Data store 110 may store the data. ML processing 120 can process data in data store 110 to develop a model of equipment 10 and automatically build digital twin 130. Once built, digital twin 130 can be used (e.g., automatically and/or with input from user of client/UI 50) to simulate operation of equipment 10. Based on the operation of digital twin 130, improvements to real-world operation of equipment 10 can be identified and implemented. Some components may communicate with one another and/or with system 100 through one or more networks (e.g., the Internet, an intranet, and/or one or more networks that provide a cloud environment) and/or by local connections (e.g., within a building management system (BMS). Indeed, communication may involve one or more of a variety of known and/or novel protocols and/or technologies (e.g., BACnet, Modbus, Lon, Dali, KNX, ANSI, Zigbee, LoRa, 3G/4G/5G, etc.). FIGS. 2-5 provide details about the processing performed by system 100.

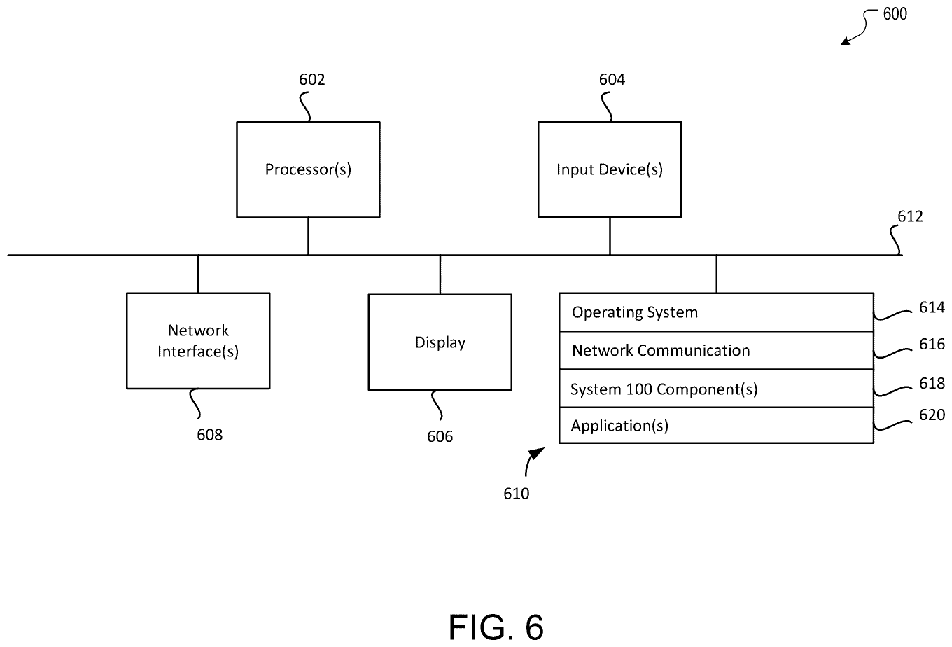

In some embodiments, system 100 components can be provided by separate computing devices communicating with one another through a network or some other connection(s). For example, data store 110, ML processing 120, and/or digital twin processing 130 may be respectively provided within different computing environments. In other embodiments, data store 110, ML processing 120, and/or digital twin processing 130 may be part of the same computing environment. Other combinations of computing environment configurations may be possible. Each component may be implemented by one or more computers (e.g., as described below with respect to FIG. 6).

Elements illustrated in FIG. 1 (e.g., system 100 (including data store 110, ML processing 120, and/or digital twin processing 130), equipment 10, sensor(s) 20, energy meter(s) 30, controller 40, and/or client/UI 50) are each depicted as single blocks for ease of illustration, but those of ordinary skill in the art will appreciate that these may be embodied in different forms for different implementations. For example, while data store 110, ML processing 120, and digital twin processing 130 are depicted separately, any combination of these elements may be part of a combined hardware, firmware, and/or software element. Likewise, while data store 110, ML processing 120, and digital twin processing 130 are each depicted as parts of a single system 100, any combination of these elements may be distributed among multiple logical and/or physical locations. Moreover, FIG. 1 shows respective single instances of data store 110, ML processing 120, and digital twin processing 130 for ease of explanation of certain operations. However, varying numbers of instances of data store 110, ML processing 120, and/or digital twin processing 130 may be possible in various embodiments. Also, while one equipment 10, two sensors 20, one energy meter 30, one controller 40, one client/UI 50, and one system 100 are illustrated, this is for clarity only, and multiples of any of the above elements may be present. In practice, there may be single instances or multiples of any of the illustrated elements, and/or these elements may be combined or co-located.

The example embodiments presented herein use a chiller as equipment 10, although this is only by way of example, and the systems and methods described herein are not limited to use with chillers. A non-exhaustive set of device(s) and/or system(s) suitable to function as equipment 10 may include any building systems related to comfort, safety, productivity, security, compliance, control, monitoring, reporting, visualization, and/or alarms. For example, equipment 10 may include HVAC elements such as air conditioning units, other heating and/or cooling units, air handler units (AHUs), fan coil units (FCUs), variable air volume (VAV) systems, boilers, chillers, variable speed drive (VSD) systems, fans, pumps, indoor air quality (IAQ) systems, occupancy control systems, etc. In further examples, equipment 10 may include BMSs, internet of things (IoT) devices, fire safety systems, security systems, power systems, lighting systems, computerized maintenance management systems (CMMS), computer-aided facility management (CAFM), etc.

FIG. 2 shows an example digital twin development and implementation process 200 according to some embodiments of the disclosure. System 100 can perform process 200 to automatically build a digital twin of equipment 10 and experiment with the digital twin to optimize control of equipment 10, for example.

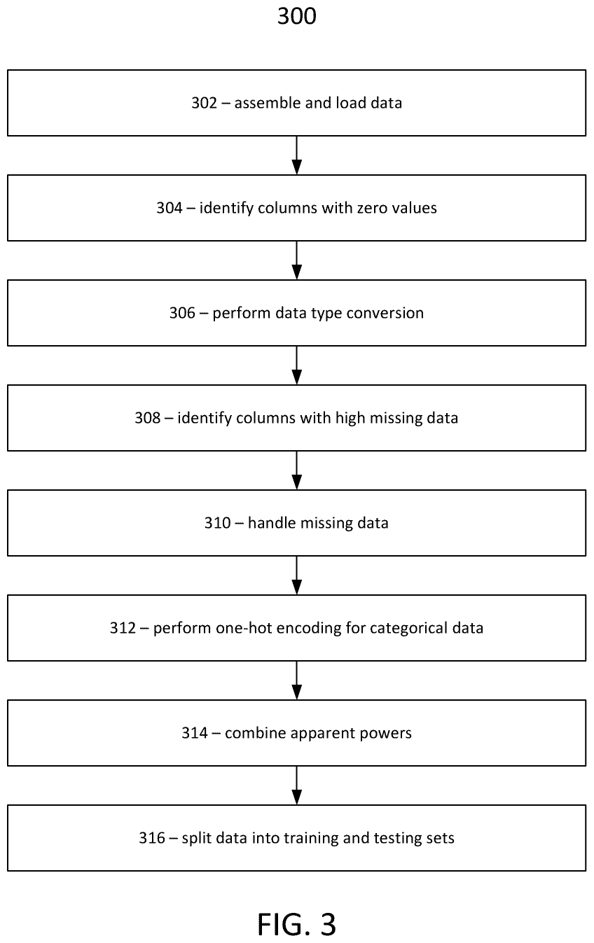

At 202, system 100 can obtain data from, and/or descriptive of, equipment 10. For example, one or more of equipment 10, sensor(s) 20, energy meter(s) 30, and/or controller 40 can send data to data store 110. Data store 110 may store the data. Data collected by data store 110 can include, but is not limited to, any data related to an input contributing to, or measurement dependent upon, energy use by equipment 10. An example process for obtaining and preparing data for subsequent use within process 200 is described below with respect to FIG. 3.

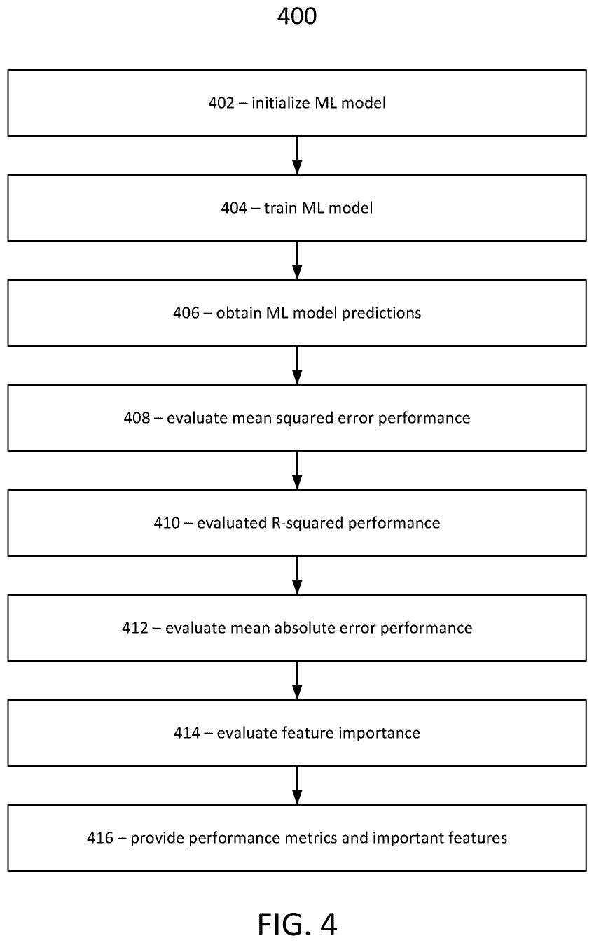

At 204, system 100 can automatically build a digital twin of equipment 10. For example, system 100 can apply data obtained at 202 as input to a ML process which, once trained on the data, can provide an accurate mathematical model of equipment 10. This model can be deployed as a digital twin with variables that can be adjusted by a user or by an automatic process to simulate performance of the real world equipment 10, as described below. An example process for automatically building a digital twin within process 200 is described below with respect to FIG. 4.

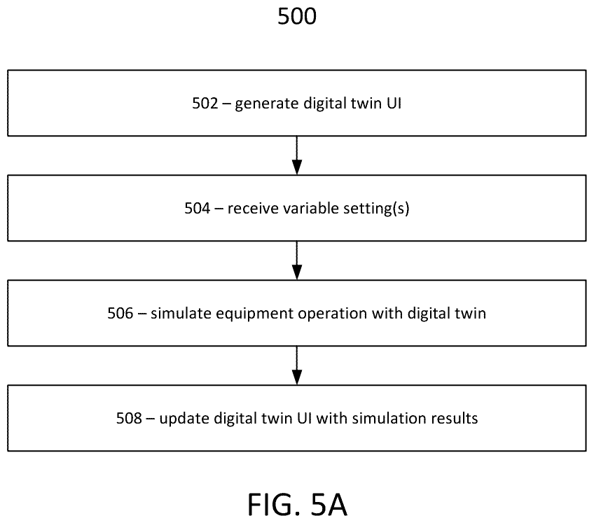

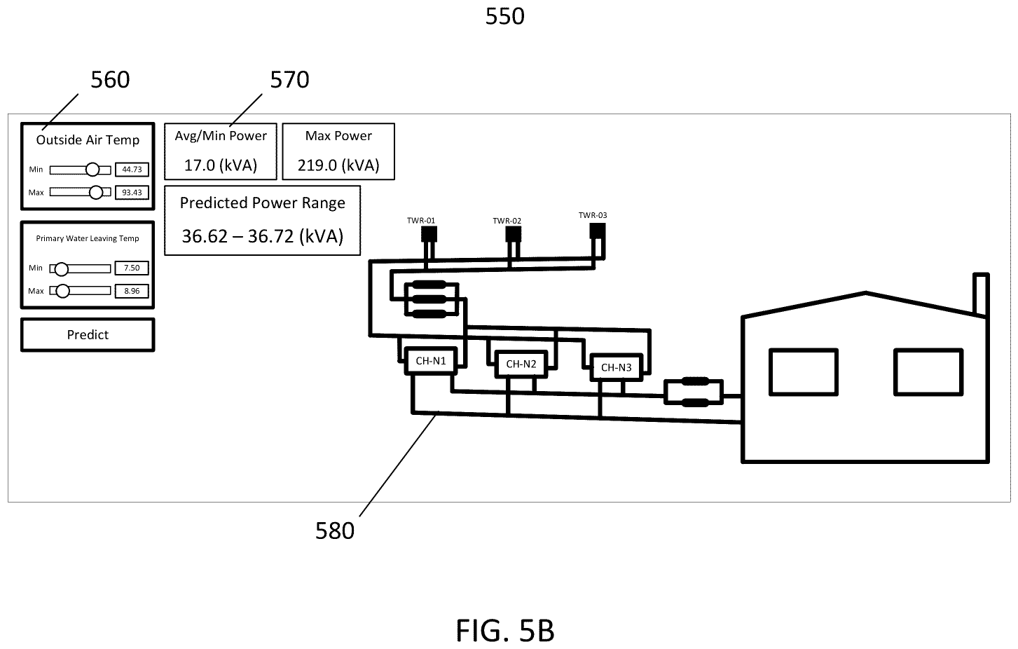

At 206, system 100 can simulate operation of equipment 10 using the digital twin. For example, system 100 can generate a UI integrating the ML model built at 204 and allowing users to specify changes in variables affecting equipment 10 operation. System 100 can use the ML model to simulate operation of the digital twin. An example simulation process and UI that may be used within process 200 is described below with respect to FIGS. 5A and 5B.

At 208, system 100 can report on the results of the simulated operation and/or implement changes to real-world operation of equipment 10. For example, after simulations are run with changes made to input variables at 206, system 100 can provide the results to client/UI 50, where a user may view them. If the results of the changes show improved operation of simulated equipment 10 (e.g., acceptable functional performance with improved operational efficiency), this will be indicated by the UI. In some embodiments, the user can adjust the real inputs to the real equipment 10 in kind, improving the operation of the real equipment 10. In some embodiments, system 100 can automatically adjust the real inputs to the real equipment 10 in kind, improving the operation of the real equipment 10. In some embodiments, this reporting may be made through UI 550 described below with respect to FIG. 5B, for example.

FIGS. 3-5 show subsets of process 200 in detail with illustrative, but not limiting, examples included to demonstrate how the disclosed embodiments can automatically build and use models of equipment 10.

FIG. 3 shows an example data collection process 300 according to some embodiments of the disclosure. System 100 can perform process 300 to gather data descriptive of equipment 10 operations and prepare the data for subsequent processing to build a digital twin of equipment 10. For example, system 100 can perform process 300 at 202 of process 200.

At 302, system 100 can assemble data from the various sources described above (e.g., equipment 10 sensor(s) 20, energy meter(s) 30, and/or controller 40) in data store 110. This can take place over a long period of time to ensure the data set is rich and detailed, for example over the course of a year or some other length of time. Once the data has been assembled in data store 110, ML processing 120 can read the data and load the data into a dataframe for subsequent processing. Data assembled by system 100 may vary according to specific equipment 10 type being modeled, or even by specific piece of equipment 10, but as an example, the following data may be gathered for a chiller in some embodiments: entering temperatures, leaving temperatures, compressor discharge pressure, condenser refrigeration pressure, condenser section pressure, condenser discharge pressure, evaporator entering temperature, condenser entering temperature, condenser leaving temperature, compressor suction temperature, chiller apparent power, chiller primary leaving temperature, compressor apparent power, compressor current, and/or compressor voltage.

At 304, ML processing 120 can identify columns within the dataframe with zero values. For example, ML processing 120 may calculate the count of zero values in each column of the dataframe. ML processing 120 can further provide visualization of the zero values, for example by generating a bar chart displaying a count of zero values and/or indicating columns or column names where the zero values are present. In some embodiments, system 100 can provide the bar chart to client/UI 50 for display to a user. The zero values can be indicative of missing or incorrect data, so identifying the zero values can allow ML processing 120 to account for such missing or incorrect data in subsequent processing.

At 306, ML processing 120 can perform data type conversion. The data sources contributing data to data store 110 at 302 may report data in a variety of formats, which may include numerically, in plain text, in a combination of number and text, in code, and/or in other formats. The ML model that will build the digital twin may require all data to have a consistent format (e.g., numeric values) or may perform better when all data has a consistent format. Accordingly, ML processing 120 can convert columns in the dataframe with object data types (e.g., text or non-numeric values) to numeric data types. ML processing 120 can use the pd.to_numeric function of the Pandas Python library or a similar function from a different library or language to make the conversion, for example. As a result, columns containing data that can be cast as numeric data are correctly identified as such for further processing.

At 308, ML processing 120 can identify columns in the dataframe with high missing data counts. ML processing 120 can use a threshold level of missing data to identify columns as having high missing data counts, such that any column with missing entry counts above some threshold value is removed. For example, ML processing 120 can identify columns with more than 80% missing data (e.g., where missing data can be identified as having not a number (NaN) values) and remove them from the dataframe in some embodiments. As a result, columns with excessive missing data, which may not contribute significantly to the analysis, may be removed. This may make the remaining processing more efficient, as ML processing 120 can process fewer columns of data moving forward.

At 310, ML processing 120 can perform processing to handle missing data, for example by filling in missing entries within the remaining columns in the dataframe. In some embodiments, ML processing 120 can fill missing values in categorical columns using forward fill (e.g., method=‘ffill’ of the Pandas Python library or a similar function from a different library or language) and/or backward fill (e.g., method=‘bfill’ of the Pandas Python library or a similar function from a different library or language) methods. In some embodiments, ML processing 120 can interpolate missing values using linear interpolation. These filling techniques may be used in combination in some embodiments. The processing to handle missing data can ensure that the dataset is adequately prepared for analysis by avoiding ML processing errors that might arise from missing data.

At 312, ML processing 120 can perform one-hot encoding for categorical data. ML processing 120 can identify any column(s) in the dataframe having categorical data therein. ML processing 120 can perform one-hot encoding on categorical columns, creating binary columns for each category within these columns. This transformation may enable subsequent processing by ML algorithms that require numerical input data, for example.

At 314, ML processing 120 can calculate the sum of some related columns in the dataframe and add the results as a new column. Accordingly, ML processing 120 can aggregate information from multiple columns into a single column for analysis or modeling. Data summed may vary according to specific equipment 10 type being modeled, or even by specific piece of equipment 10, but as an example, a chiller may have multiple apparent power measurements which may be summed together (e.g., Chiller 01 Apparent Power+Chiller 02 Apparent Power+Chiller 03 Apparent Power).

At 316, ML processing 120 can have a set of processed data ready for use in creating a digital twin. In some embodiments, ML processing 120 can split the data into two sets, a training set and a testing set. This division of data may allow the ML model to be trained on one subset of the processed data and tested on another subset of the processed data to evaluate the performance of the trained ML model.

FIG. 4 shows an example digital twin building process 400 according to some embodiments of the disclosure. As described above, once data has been collected and prepared (e.g., by process 300 of FIG. 3), system 100 can build a digital twin of equipment 10. For example, system 100 can perform process 400 at 204 of process 200. In summary, the digital twin building process 400 may involve training a random forest regressor or other ML model, making predictions on a test dataset, and assessing the model's performance using a variety of metrics. The reported metrics may provide valuable insights into the model's accuracy and its ability to explain variance in the target variable.

At 402, ML processing 120 can initialize an ML model. For example, some embodiments may initialize a random forest regressor model using Python RandomForestRegressor ( ) function or another function for initializing a random forest regressor model. Random forest is a machine learning algorithm used for regression tasks, and embodiments described herein may use this model to simulate equipment 10 as described in detail below. It will be understood that other ML models may be used in other embodiments without departing from the scope of the disclosure.

At 404, ML processing 120 can train the ML model initialized at 402. For example, ML processing 120 can train the random forest regressor model using the training data assembled by process 300 with Python model.fit(X_train, y_train) function or another function for training. Training may allow the model to learn patterns and relationships in the training data.

At 406, ML processing 120 can run the trained ML model to obtain one or more predictions and evaluate those predictions. For example, ML processing 120 can designate a target variable and run the test dataset obtained through process 300 through the trained ML model. ML processing 120 can thereby predict the target variable using the trained model with Python y_pred=model.predict(X_test) function or another test function, for example. ML processing 120 can assess how well the model generalizes to unseen data by comparing the result of ML processing 120 to the real values within data store 110.

At 408, ML processing 120 can evaluate ML performance by calculating mean squared error (MSE). ML processing 120 can calculate MSE using Python mean_squared_error (y_test,y_pred) or another MSE calculation function, for example. MSE measures the average squared difference between predicted and actual values. The calculated MSE value (e.g., 59.6) quantifies the average squared difference between predicted and actual values. Lower values indicate that the model's predictions are closer to the actual values, implying better model accuracy.

At 410, ML processing 120 can evaluate ML performance by calculating an R-squared (R2) score. ML processing 120 can calculate the R2 score using Python r2_score(y_test, y_pred) or another R2 calculation function, for example. R2 (e.g., 0.96) measures the proportion of variance in the dependent variable (target) that is predictable from the independent variables (features), i.e., the proportion of variance in the target variable that is explained by the model. R2 provides an indication of how well the model fits the data. Higher R2 values (closer to 1) indicate a better fit.

At 412, ML processing 120 can evaluate ML performance by calculating mean absolute error (MAE). For example, ML processing 120 can calculate MAE using Python mean_absolute_error(y_test,y_pred) or another MAE calculation function, for example. The MAE value (e.g., 1.9) represents the average absolute difference between predicted and actual values. Lower MAE values indicate smaller errors in prediction.

At 414, ML processing 120 can evaluate feature importance for features within the dataframe. For example, ML processing 120 can calculate feature importance scores using Python model.feature_importances_function or another feature importance calculation function, for example, and identify the most important features. Feature importance helps understand which features have the most influence on the model's predictions, which may yield insights into the factors driving the predictions.

At 416, ML processing 120 can provide performance metric and important feature data as outputs indicating a completed evaluation of the ML model. For example, system 100 can provide the outputs to client/UI 50 for display to a user in some embodiments. The calculated MSE, R2, and MAE values provide a summary of how well the model performs in terms of accuracy and error. The names and importance scores of the top features may allow stakeholders to identify and focus on the most significant factors influencing the target variable. Accordingly, a user may be able to approve the model as representing an accurate digital twin of equipment 10.

In some embodiments, processing at 406-416 may be optional, and an ML model may be simply deployed once trained at 404. However, by performing the evaluation processing at 406-416, at least one test model has been confirmed to have good performance. For example, a calculated MSE value of 59.6 indicates that, on average, the squared difference between the model's predictions and the actual values is relatively small. A lower MSE signifies that the model's predictions are closer to the actual values. In this case, the MSE value is relatively low, suggesting good accuracy. A calculated MAE value of 1.9 indicates that, on average, the absolute difference between the model's predictions and the actual values is small. A lower MAE implies that the model's predictions are generally close to the actual values, which is a positive sign of accuracy. A calculated R2 score of 0.96 is close to 1. R2 measures the proportion of variance in the target variable that is explained by the model. A high R2 score indicates that the model is successful in explaining a significant portion of the variance in the data. In this case, an R2 score of 0.96 suggests that the model is an excellent fit for the data. In summary, low MSE and MAE values indicate small prediction errors, while a high R2 score indicates that the model explains a large portion of the variance in the target variable. These metrics collectively suggest that the model is performing well and making accurate predictions on the given dataset.

FIG. 5A shows an example simulation process 500, and FIG. 5B shows an example simulation UI 550, according to some embodiments of the disclosure. System 100 can perform process 500 to simulate equipment 10 operations using a digital twin of equipment 10 and display the simulation. At least some tests performed within simulation process 500 can be “what-if” analyses where operational scenarios are simulated and digital twin performance in such scenarios is evaluated, enabling changes to the real equipment 10 to realize performance and/or efficiency improvements expected in view of digital twin performance. For example, sequence of operations and/or settings may be altered for the digital twin, changes due to these alterations may be evaluated, and real-world sequences of operations and/or settings may be specified for equipment 10 according to the evaluation. In some embodiments, system 100 can perform process 500 at 206-208 of process 200.

At 502, digital twin processing 130 can generate a digital twin UI (e.g., UI 550 of FIG. 5B). For example, a visual UI model of equipment 10 may be built using Unity or another visualization tool in some embodiments. In other embodiments, the digital twin may be entirely mathematical without a graphical component. In any case, digital twin processing 130 can use the ML model as configured through process 400 of FIG. 4 described above. Moreover, digital twin processing 130 can generate a UI that enables user interaction with simulation parameters. In some embodiments, system 100 can send data to client/UI 50 allowing client/UI 50 to display the UI generated at 502.

As an example of a visual UI model, FIG. 5B shows UI 550 with a chiller serving as equipment 10. UI 550 may include one or more input interface elements 560 and one or more output interface elements 570. For visual (e.g., 3D) models, UI 550 may include a graphical representation 580 of the digital twin of equipment 10.

At 504, digital twin processing 130 can receive variable setting(s) through UI 550. Digital twin processing 130 can provide input interface elements 560 for any variables that can be manipulated for equipment 10. For example, a chiller may have hundreds of inputs into the ML model built as described above, but only a few may be variable by changes to the environment in which the chiller operates or by changes to control settings of the chiller. Digital twin processing 130 can provide input interface elements 560 for those inputs that are variable by environmental or control setting changes, or a subset thereof. In the illustrated example, input interface elements 560 for outside air temperature and primary water leaving temperature are shown, although these are provided only as examples and are not intended to be limiting for all embodiments. A user may enter changes within one or more input interface elements 560.

At 506, digital twin processing 130 can simulate equipment 10 operation using the digital twin ML model and the variable setting(s) received at 504. For example, digital twin processing 130 can provide the inputs to ML processing 120, which may run the trained ML model for equipment 10 using the inputs received at 504. Digital twin processing 130 can receive the results of this simulation from ML processing 120.

At 508, digital twin processing 130 can update UI 550 with simulation results from 506. Digital twin processing 130 can provide output interface elements 570 for one or more indicators of operational effectiveness and/or efficiency of the digital twin. These indicators may be some or all of the outputs of ML model simulation performed at 506. In the illustrated example, output interface elements 570 for average/minimum power used, maximum power used, and predicted power range are shown, although these are provided only as examples and are not intended to be limiting for all embodiments. Digital twin processing 130 can provide these outcomes of ML model simulation performed at 506 in output interface elements 570 UI 550 as shown, for example.

By varying the input and/or output interface elements presented in UI 550, various embodiments may provide additional and/or different functionalities or uses beyond those shown in FIG. 5B. Such functionalities or uses may be derived from the same ML model. For example, instead of, or in addition to, power usage as illustrated in the example, embodiments may simulate equipment 10 operation to provide details about the following: chiller staging and sequencing optimization (e.g., varying staging/sequencing and reporting on power use, operational efficiency, and/or failure potential); cooling tower optimization; seasonal optimization (e.g., varying outside temperatures and/or other conditions to determine how to optimize operations in different weather conditions); optimized start/stop; occupancy based optimization (e.g., varying conditions affected by changes in occupancy); best-of-breed chiller control strategies; demand charge/peak load reduction; capacity management; automatic demand response (ADR) analysis; fault and/or failure prediction; and/or condition based maintenance optimization.

Moreover, additional data may be integrated into UI 550. For example, live data from BMS/IoT sensors, XRS, and/or contextualized metadata may be integrated with Digital Twin visualization described herein.

In addition to the technical benefits described in detail above, the simulations made possible by the disclosed digital twin systems and methods may provide rapid proof-of-concept (POC) value demonstration, training for facility managers on a simulated environment instead of real one, training data/environment data provisioning to HVAC educational institutions, capital planning information, enhanced advisory services, optimized equipment selection, determining/demonstrating value of recommended changes, simulating recommended changes before making changes to real-world equipment 10, and/or providing equipment 10 performance feedback to manufacturers.

FIG. 6 shows a computing device 600 according to some embodiments of the disclosure. For example, computing device 600 may function as a single system 100 or any portion(s) thereof, or multiple computing devices 600 may function as a system 100.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include the system elements and/or the instructions that enable computing device 600 to perform functions of system 100 as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method comprising:
receiving, by at least one processor, data descriptive of operation of equipment;
storing, by the at least one processor, the data in a data store;
building, by the at least one processor, a digital twin of the equipment using the data, the building comprising:
training at least one machine learning (ML) model on at least a portion of the data in the data store; and
building a model accessible by a user interface (UI) and comprising at least one parameter determined by the trained ML model, wherein the model includes at least one user-variable input; and
simulating, by the at least one processor, operation of the equipment using the digital twin in response to receiving an entry in the at least one user-variable input.

2. The method of claim 1, wherein the data is received from at least one of the equipment, one or more sensors, one or more energy meters, and one or more controllers.

3. The method of claim 1, further comprising pre-processing, by the at least one processor, the data before the training.

4. The method of claim 3, wherein the pre-processing comprises at least one of:
identifying one or more zero values;
converting at least a portion of the data to a numeric format;
removing at least one data column with a missing data count above a threshold;
filling in at least one missing data entry with dummy data;
performing one-hot encoding for categorical data; and
summing at least two data entries.

5. The method of claim 1, wherein the ML model comprises a random forest regression model.

6. The method of claim 1, further comprising evaluating, by the at least one processor, performance of the ML model before the building of the model accessible by the UI.

7. The method of claim 6, wherein the evaluating comprises at least one of:
using a test dataset to run the trained ML model;
calculating mean squared error of the trained ML model;
calculating an R-squared score for the trained ML model;
calculating mean absolute error of the trained ML model; and
evaluating feature importance for features within the data.

8. The method of claim 1, wherein the building of the model accessible by the UI comprises building a 3D model of the equipment.

9. The method of claim 1, wherein the simulating comprises running the trained ML model with the entry as an input.

10. The method of claim 1, wherein the simulating comprises at least one of updating the UI with results of the simulating and adjusting an operational input to the equipment based on the results of the simulating.

11. A system comprising:
at least one processor; and
at least one non-transitory computer readable medium storing instructions that, when executed by the at least one processor, cause the at least one processor to perform processing comprising:
storing, by the at least one processor, data descriptive of operation of equipment in a data store;
building a digital twin of the equipment using the data, the building comprising:
training at least one machine learning (ML) model on at least a portion of the data in the data store; and
building a model accessible by a user interface (UI) and comprising at least one parameter determined by the trained ML model, wherein the model includes at least one user-variable input; and
simulating operation of the equipment using the digital twin in response to receiving an entry in the at least one user-variable input.

12. The system of claim 11, wherein the data is received from at least one of the equipment, one or more sensors, one or more energy meters, and one or more controllers.

13. The system of claim 11, wherein the processing further comprises pre-processing the data before the training.

14. The system of claim 13, wherein the pre-processing comprises at least one of:
identifying one or more zero values;
converting at least a portion of the data to a numeric format;
removing at least one data column with a missing data count above a threshold;
filling in at least one missing data entry with dummy data;
performing one-hot encoding for categorical data; and
summing at least two data entries.

15. The system of claim 11, wherein the ML model comprises a random forest regression model.

16. The system of claim 11, wherein the processing further comprises evaluating performance of the ML model before the building of the model accessible by the UI.

17. The system of claim 16, wherein the evaluating comprises at least one of:
using a test dataset to run the trained ML model;
calculating mean squared error of the trained ML model;
calculating an R-squared score for the trained ML model;
calculating mean absolute error of the trained ML model; and
evaluating feature importance for features within the data.

18. The system of claim 11, wherein the building of the model accessible by the UI comprises building a 3D model of the equipment.

19. The system of claim 11, wherein the simulating comprises running the trained ML model with the entry as an input.

20. The system of claim 11, wherein the simulating comprises at least one of updating the UI with results of the simulating and adjusting an operational input to the equipment based on the results of the simulating.
